(19) United States
(12) Patent Application Publication
(10) Pub. No.: US 2016/0271726 A1
(43) Pub. Date: Sep. 22, 2016

(54) RACK MANUFACTURING APPARATUS AND RACK MANUFACTURING METHOD

(71) Applicant: NETUREN CO., LTD., Tokyo (JP)

(72) Inventors: Ryosuke SUZUKI, Tokyo (JP); Makoto NOMURA, Tokyo (JP); Takashi YAMAWAKI, Tokyo (JP)

(73) Assignee: NETUREN CO., LTD., Tokyo (JP)

(21) Appl. No.: 14/442,329

(22) PCT Filed: Dec. 27, 2013
(86) PCT No.: PCT/JP2013/085349

§ 371 Date: May 12, 2015

(30) Foreign Application Priority Data
Dec. 27, 2012 (JP) 2012-286148

(51) Int. Cl. B23K 20/12

(52) U.S. Cl. CPC B23K 20/129

(57) ABSTRACT

A rack manufacturing apparatus and a rack manufacturing method are provided. The rack manufacturing apparatus includes a first support portion configured to support a hollow or solid first bar on which first rack teeth are formed, a second support portion configured to support a hollow or solid second bar such that an axial center line of the second bar is aligned with an axial center line of the first bar, a base configured to cause the second support portion to approach the first support portion, and a rotary driving portion configured to rotate the second support portion about the axial center line of the second support portion relative to the first support portion so as to join an end portion of the first bar and an end portion of the second bar by a friction pressure welding.

### TECHNICAL FIELD

The present invention relates to an apparatus and a method for manufacturing a rack bar for use in a steering apparatus of a vehicle, in particular, a rack bar suitable for use in an electric power steering apparatus in which a steering pinion coupled to a steering wheel is engaged with the rack bar so as to slide the rack bar to turn the wheels of the vehicle and in which an output of a motor controlled in accordance with a steering torque is transmitted to an auxiliary pinion engaging with the rack bar at a location separated from the steering pinion to assist the steering.

### BACKGROUND ART

A rack and pinion mechanism for use in an electric power steering (EPS) apparatus may have a rack-and-pinion combination at a single location (a “single-pinion type”), or may have rack-and-pinion combinations at two location (a “double-pinion type”) using a rack bar for the EPS (see, e.g., JP 4397083 B2). A rack toothed portion of a rack bar for use in the single-pinion type may be formed by pressing or forging using a mandrel.

The rack bar for use in the double-pinion type however has rack-toothed portions at respective axial end portions of the rack bar, and angular positions (phases) of the two rack-toothed portions with respect to an axis of the rack bar may be shifted from each other by 0 to 45 degrees. Thus, it requires a special pressing machine. Further, the rack bar having the phase difference described above cannot be manufactured with a forging machine using a mandrel.

### SUMMARY OF INVENTION

It is an object of the present invention to provide an apparatus and a method for manufacturing a rack bar having rack toothed portions at two locations, without using a special machine forming the two rack toothed portions.

According to an aspect of the present invention, a rack manufacturing apparatus and a rack manufacturing method are provided.

The rack manufacturing apparatus includes a first support portion configured to support a hollow or solid first bar on which first rack teeth are formed, a second support portion configured to support a hollow or solid second bar such that an axial center line of the second bar is aligned with an axial center line of the first bar, a base configured to cause the second support portion to approach the first support portion, and a rotary driving portion configured to rotate the second support portion about the axial center line of the second support portion relative to the first support portion so as to join an end portion of the first bar and an end portion of the second bar by a friction pressure welding.

The rack manufacturing method includes steps of supporting a hollow or solid first bar on which first rack teeth are formed, supporting a hollow or solid second bar such that an axial center line of the second bar is aligned with an axial center line of the first bar, rotating the second bar about the axial center line of the second bar relative to the first bar; and pressure welding an end portion of the first bar and an end portion of the second bar.

### BRIEF DESCRIPTION OF DRAWINGS

FIG. 1 is a view of a rack and pinion assembly having a double-pinion rack bar manufactured by a double-pinion rack manufacturing apparatus according to an embodiment of the present invention.

FIG. 2 is a plan view illustrating the double-pinion rack bar in a partially cut manner.

FIG. 3 is a diagram illustrating a configuration of the double-pinion rack manufacturing apparatus.

FIG. 4 is a diagram illustrating a double-pinion rack manufacturing process using the double-pinion rack manufacturing apparatus.

FIG. 5 is another diagram illustrating the double-pinion rack manufacturing process.

FIG. 6 is another diagram illustrating the double-pinion rack manufacturing process.

FIG. 7 is another diagram illustrating the double-pinion rack manufacturing process.

FIG. 8 is another diagram illustrating the double-pinion rack manufacturing process.

FIG. 9 is another diagram illustrating the double-pinion rack manufacturing process.

FIG. 10 is another diagram illustrating the double-pinion rack manufacturing process.

FIG. 11 is another diagram illustrating the double-pinion rack manufacturing process.

FIG. 12 is a diagram illustrating a double-pinion rack manufacturing apparatus according to another embodiment of the present invention.

FIG. 13 is a diagram illustrating a double-pinion rack manufacturing process using the double-pinion rack manufacturing apparatus of FIG. 12.

FIG. 14 is another diagram illustrating the double-pinion rack manufacturing process.

### DESCRIPTION OF EMBODIMENTS

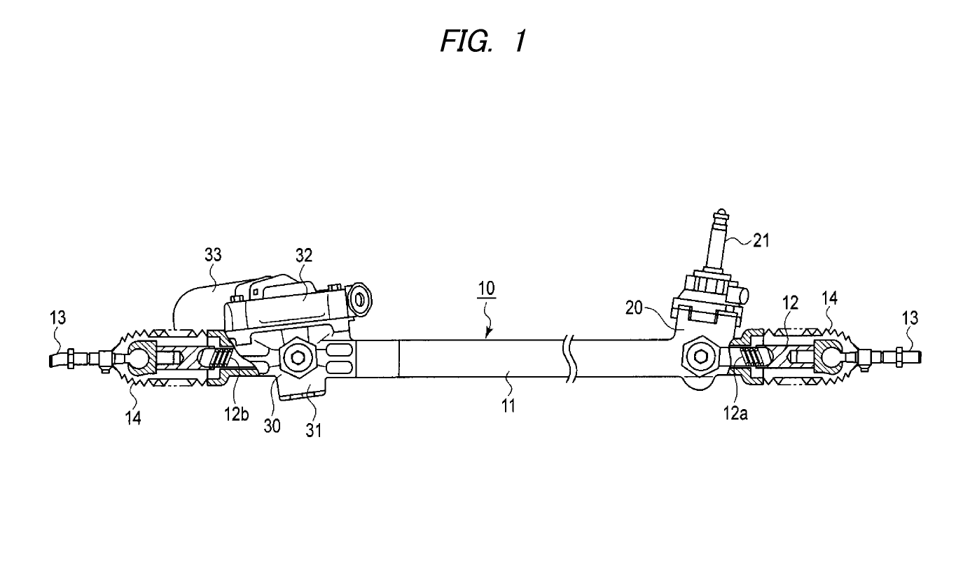

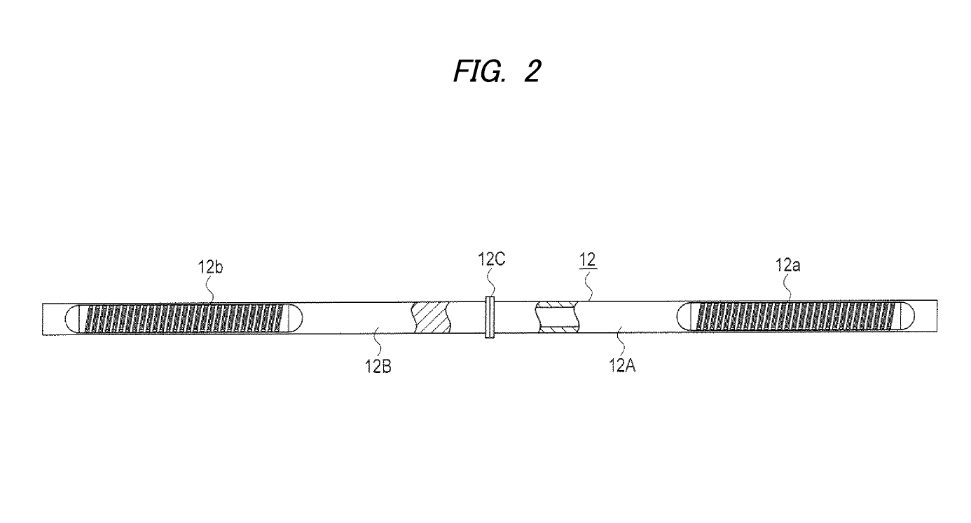

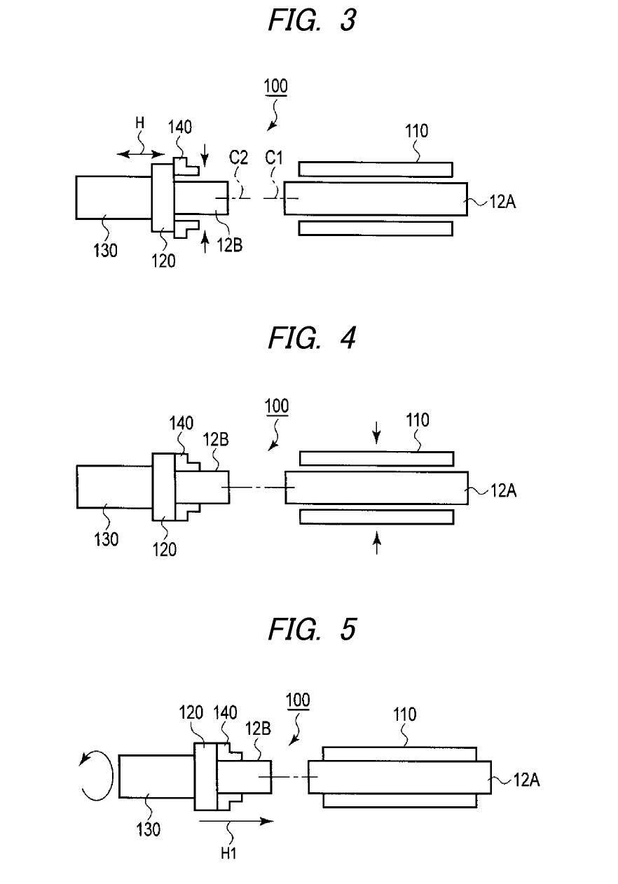

FIG. 1 is a view of a rack and pinion assembly in which a double-pinion rack bar 12 is incorporated. The double-pinion rack bar 12 is manufactured by a double-pinion rack manufacturing apparatus 100 (a rack manufacturing apparatus) according to an embodiment of the present invention. FIG. 2 is a plan view of the double-pinion rack bar 12. FIG. 3 is a diagram illustrating a configuration of the double-pinion rack manufacturing apparatus 100.

The rack and pinion assembly 10 includes a substantially cylindrical rack housing 11 extending in a transverse direction of a vehicle. The double-pinion rack bar 12 is accommodated inside the housing 11 so as to be slidable in the transverse axial direction.

The double-pinion rack bar 12 extend outwards from end-openings of the rack housing 11, and tie rods 13 are coupled to the respective end portions of the double-pinion rack bar 12 via respective joints. The tie rods 13 extend laterally from boots 14 covering the joints respectively. The tie rods 13 are moved in accordance with the movement of the double-pinion rack bar 12, thereby steering the wheels of the vehicle.

A steering gear box 20 is provided at a right end portion of the rack housing 11. An input shaft 21 is supported by the steering gear box 20 via a bearing so that the input shaft 21 is pivotable. The input shaft 21 is coupled to a steering shaft, to which a steering wheel is integrally attached via a joint. The input shaft 21 is provided with a steering pinion (not shown).

The steering pinion is engaged with a rack-toothed portion 12a (first rack teeth) of the double-pinion rack bar 12. The steering force transmitted to the input shaft 21 according to the turning operation of the steering wheel rotates the steering pinion having helical teeth engaged with the toothed portion 12a, causing the double-pinion rack bar 12 to slide in a transverse axial direction.

An auxiliary gear box 30 is provided at a left end portion of the rack housing 11. The auxiliary gear box 30 includes a pinion cylinder part 31 extending in a slightly tilted vertical direction with respect to the rack housing 11, and a rack guide cylinder part 32 extending perpendicularly to the pinion cylinder part 31.

An auxiliary pinion (not shown) is accommodated inside the pinion cylinder part 31 such that the auxiliary pinion is engaged with a rack-toothed portion 12b (second rack teeth) of the double-pinion rack bar 12. A motor 33 is attached to the auxiliary gear box 30, such that a driving shaft of the motor 33 rotates the auxiliary pinion having helical teeth meshed with the rack-toothed portion 12b of the double-pinion rack bar 12, causing the double-pinion rack bar 12 to slide in a transverse axial direction.

The motor 33 is controlled in accordance with the steering torque of the steering wheel detected through the input shaft 21. The steering operation is performed such that a manual steering force is transmitted to the double-pinion rack bar 12 via the steering pinion, and the driving force of the motor 33 to be controlled depending on the steering torque and is applied to the same double-pinion rack bar 12 via the auxiliary pinion to assist the manual steering operation.

FIG. 2 is a plan view of the double-pinion rack bar 12. The double-pinion rack bar 12 has a first toothed portion 12a and a second toothed portion 12b. Angular positions (phases) of the first toothed portion 12a and the second toothed portion 12b around the axis of the double-pinion rack bar are different from each other by about 0 to 45 degrees.

The double-pinion rack bar 12 is formed by joining a first rack bar 12A and a second rack bar 12B. The first rack bar 12A is provided by forming the first rack teeth 12a on a hollow shaft. The second rack bar 12B is provided by forming the second rack teeth 12b on a solid shaft. Reference sign 12C in FIG. 2 denotes a joint portion at which the first and second rack bars 12A, 12B are joined together.

As schematically shown in FIG. 3, the double-pinion rack manufacturing apparatus 100 includes a clamp device 110 (first support portion), a rotary driving portion 130 mounted to a base 120, and a chuck device 140 (second support portion) attached to the rotary driving portion 130. The double-pinion rack manufacturing apparatus 100 is installed on a floor surface or the like in a fixed manner. The clamp device 110 supports the first rack bar 12A and the chuck device 140 supports the second rack bar 12B such that the axial center lines C1, C2 of the first and second rack bars 12A, 12B are aligned with each other. As shown in FIG. 3, the chuck device 140 may be shorter than the clamp device 110 in a direction of the axial center line C2 around which the second rack bar 12B is rotated by the rotary driving portion 130.

The clamp device 110 is configured to support the first rack bar 12A having the first rack teeth 12a such that the first rack bar 12A is attachable and detachable.

The base 120 is configured to cause the chuck device 140 (second support portion) to approach the clamp device 110 (first support portion). For example, in the present embodiment, the base 120 is configured to move the rotary driving portion 130 back and forth in the direction H in FIG. 3. The rotary driving portion 130 is configured to rotate the chuck device 140 about the axial center line thereof relative to the clamp device 110.

The double-pinion rack manufacturing apparatus 100 is configured to manufacture the double-pinion rack bar 12 in a following manner. That is, as shown in FIG. 3, the second rack bar 12B is supported by the chuck device 140. Next, as shown in FIG. 4, the first rack bar 12A is supported by the clamp device 110. In this state, the axial center line C1 of the first rack bar 12A and the axial center line C2 of the second rack bar 12B are aligned.

Next, as shown in FIG. 5, the rotary driving portion 130 is actuated to rotate the second rack bar 12B about its axial center line relative to the axial center line of the first rack bar. Then, the second rack bar 12B is moved forward in the direction H1 in FIG. 5.

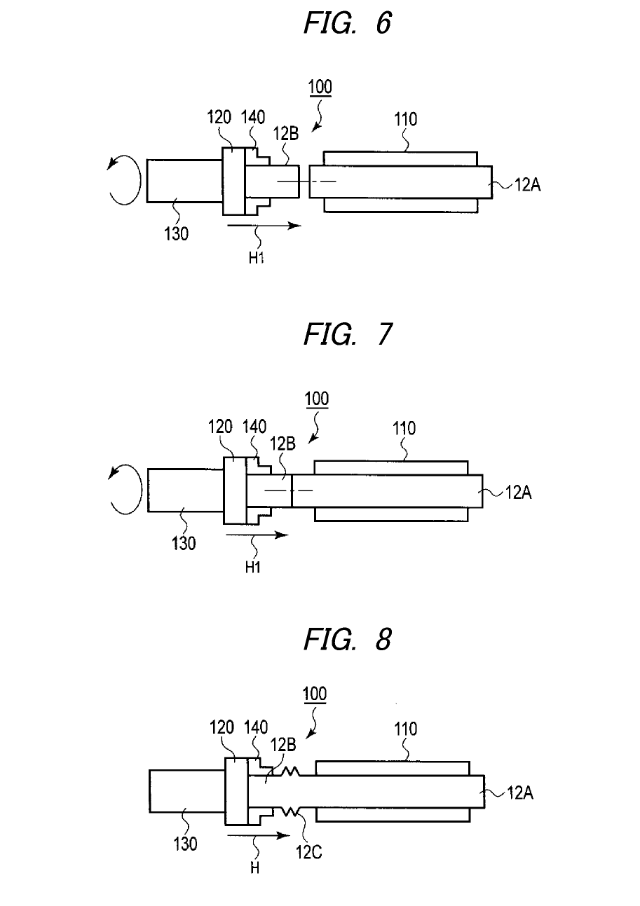

Next, as shown in FIG. 6, the base 120 slowly moves the second rack bar 12B forward (slow feed) in the direction H1 in FIG. 6 towards the first rack bar 12A, so as to cause the second rack bar 12A to contact the first rack bar 12A and as shown in FIG. 7. Accordingly, fiction heat is generated to cause a metal structure to change, and pressure is applied as well, so that the first and second rack bars 12A, 12B are joined together by friction pressure welding.

Further, as shown in FIG. 8, the operation of the rotary driving portion 130 is stopped instantly. The operation of the rotary driving portion 130 is stopped such that a predetermined phase difference around the axial center line is given to the first and second rack bars 12A, 12B. The degree of precision of the phase is about ±0.1°, which does not cause a problem in practice.

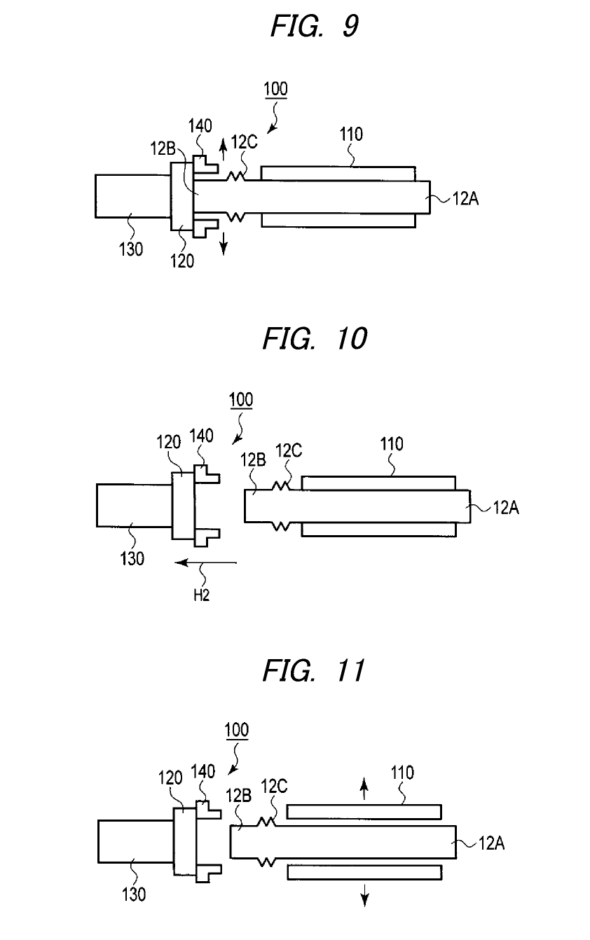

Next, as shown in FIG. 9, the second rack bar 12B is detached from the chuck device 140, and as shown in FIG. 10, the base 120 is moved backward in the direction H2 in FIG. 9. As shown in FIG. 11, at the time when returned to an initial position, the operation of the base 120 is stopped, and the first rack bar 12A is detached from the clamp device 110.

According to the double-pinion rack manufacturing apparatus 100 described above, even when the angular positions (phases) of the respective toothed portions of the rack bar around the axis of the rack bar are different from each other by about 45 degrees or more, the rack bars can be joined together with a predetermined phase difference without using a special pressing machine. Further, even when the rack bars have the rack toothed portions formed by a forging machine using a mandrel, the rack bars can also be joined. Further, it is also possible to join the first rack bar 12A having a hollow shaft portion and the second rack bar 12B having a solid shaft portion.

The joint portion 12C is formed by firmly joining the first and second rack bar 12A, 12B with friction heat and pressure, whereby the joint portion 12C has higher mechanical strength than a material of the first rack bar 12A and/or the second rack bar 12B. Accordingly, crack is not created at the joint portion 12C.

The first rack bar 12A having the hollow shaft portion is arranged on the steering side, and may be subjected to a cold sequential forging suitable for forming teeth having complex configuration such as variable gear ratio (VGR) or the like. The second rack bar 12B having the solid shaft portion is arranged on the assisting side, and may be subjected to a cutting suitable for forming teeth having a simple confirmation and requiring sufficient tooth width and tooth height. Further, the double-pinion rack bar 12 may be configured to have a hollow shaft portion along about ⅔ of its length in the axial center line, thereby contributing to making the rack bar 12 lightweight.

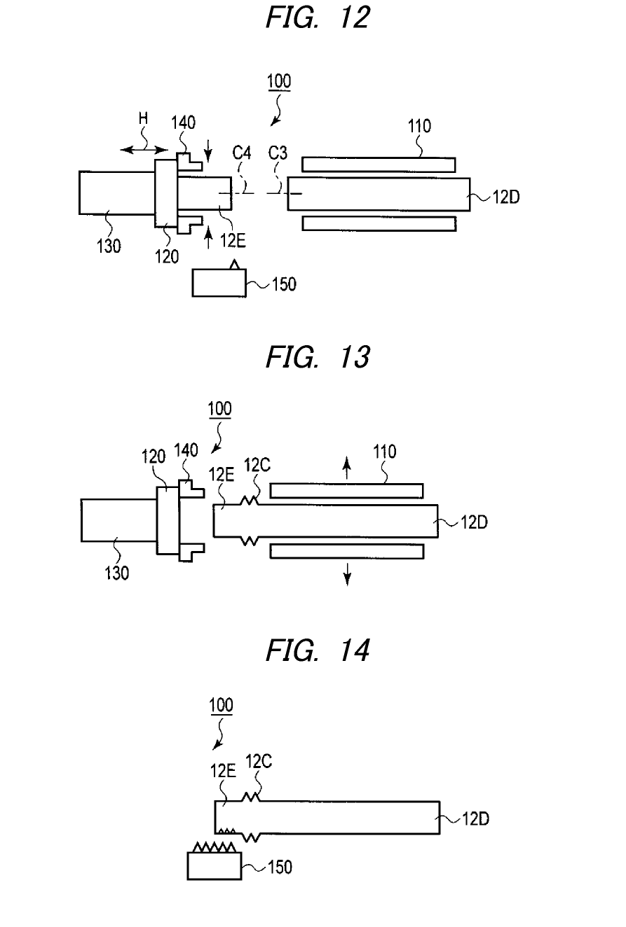

FIG. 12 is a diagram illustrating a double-pinion rack manufacturing apparatus 100A according to another embodiment of the present invention. The double-pinion rack bar 12 to be manufactured by the apparatus is the same as described in the foregoing. In FIG. 12, the portions having the same function as those shown in FIG. 3 are denoted by same reference signs as in FIG. 3, and detailed description thereof will be omitted.

As shown in FIG. 12, the double-pinion rack manufacturing apparatus 100A includes a clamp device 110 (first support portion), a rotary driving portion 130 mounted on a base 120, a chuck device 140 (second support portion) attached to the rotary driving portion 130, and a machining device 150 such as a broaching machine or the like. The double-pinion rack manufacturing apparatus 100A is installed on a floor surface or the like in a fixed manner.

The clamp device 110 and the chuck device 140 support a first bar 12D and a second bar 12E such that an axial center line C3 of the first bar 12D and an axial center line C4 of the second bar 12E are aligned with each other. The first bar 12D has a hollow shaft portion on which a rack-toothed portion 12a (first rack teeth) is already formed. The second bar 12E has a solid shaft portion on which a rack-toothed portion 12b (second rack teeth) is not yet formed.

With the double-pinion rack manufacturing apparatus 100A, as shown in FIG. 12, after the first bar 12D and the second bar 12E are respectively supported by the clamp device 110 and the chuck device 140, a double-pinion rack bar 12 is manufactured as shown in FIGS. 4 to 10. As shown in FIG. 13, when joining is completed, the first and second bars 12D and 12E are respectively released from the clamp device 110 and the chuck device 140.

Next, as shown in FIG. 14, rack teeth 12b are formed on the second bar 12E using the machining device 150.

The double-pinion rack manufacturing apparatus 100A provides the same advantageous effect as in the double-pinion rack manufacturing apparatus 100. In addition, because the rack-toothed portion 12b is formed after the first and second bars 12D and 12E are joined together, the angular positions of the rack-toothed portions 12a, 12b about axial center line thereof can be determined in high precision without depending on the precision of position determination about axial center line with respect to the rotary driving portion 130, so that high quality double-pinion rack bar 12 can be provided.

While the hollow rack bar and the solid rack bar are joined together in the embodiments described above, the present invention is also applicable in a case of joining two hollow rack bars or joining two solid rack bars. Further, the hollow rack bar and the solid rack bar can be joined together even when the arrangement of the hollow rack bar and the solid rack bar is laterally reversed. Thus, hollow and/or solid bars can be selected and joined together depending on a desired function, so the degree of freedom in designing the double-pinion rack bar is improved.

The present invention is not limited to the embodiments described above. For example although in the above embodiments, the first rack bar is fixed and the second rack bar is rotated, it is also possible to provide other configuration in which both rack bars are rotated. Further, various changes and modifications may be made without departing from the scope of the present invention as defined by the appended claims.

This application is based on Japanese Patent Application No. 2012-286148 filed on Dec. 27, 2012, the entire content of which is incorporated herein by reference.

1. A rack manufacturing apparatus comprising:
a first support portion configured to support a hollow or solid first bar on which first rack teeth are formed;
a second support portion configured to support a hollow or solid second bar such that an axial center line of the second bar is aligned with an axial center line of the first bar;
a base configured to cause the second support portion to approach the first support portion;
a rotary driving portion configured to rotate the second support portion about the axial center line of the second support portion relative to the first support portion so as to join an end portion of the first bar and an end portion of the second bar by a friction pressure welding.

2. The rack manufacturing apparatus according to claim 1, wherein the second support portion is configured to support the solid second bar.

3. The rack manufacturing apparatus according to claim 2, further comprising a machining device configured to form second rack teeth on the second bar that has been joined to the first bar.

4. The rack manufacturing apparatus according to claim 1, wherein the second support portion is configured to support the second bar on which second rack teeth are formed.

5. A rack manufacturing method comprising:
supporting a hollow or solid first bar on which first rack teeth are formed;
supporting a hollow or solid second bar such that an axial center line of the second bar is aligned with an axial center line of the first bar;
rotating the second bar about the axial center line of the second bar relative to the first bar;
pressure welding an end portion of the first bar and an end portion of the second bar;
stopping the rotation of the second bar; and
releasing the second bar.

6. The rack manufacturing method according to claim 5, wherein the supporting the second bar comprises supporting the solid second bar.

7. The rack manufacturing method according to claim 6, further comprising forming second rack teeth on the second bar that has been joined to the first bar.

8. The rack manufacturing method according to claim 5, wherein the supporting the second bar comprises supporting the second bar on which second rack teeth are formed.
